(19) United States
(12) Patent Application Publication
(10) Pub. No.: US 2011/0132471 A1
(43) Pub. Date: Jun. 9, 2011

(54) HYDRAULIC VALVE DEVICE

(76) Inventors: Windfred Rub, Waldshut-Tiengen (DE); Sacha A. Biwersi, Perl (DE)

(21) Appl. No.: 12/737,526

(22) PCT Filed: Jul. 24, 2009
(86) PCT No.: PCT/EP2009/005378

§ 371 Date: Feb. 15, 2011

(30) Foreign Application Priority Data
Jul. 29, 2008 (DE) 102008035212.8

(51) Int. Cl. F16K 35/00

(52) U.S. Cl. 137/383

(57) ABSTRACT

The invention relates to a hydraulic valve device having a fluid port arrangement (10) and having a movable control device (16) for at least partially controlling individual ports (P), (R), (LS), (P′_{A}), (P′_{B}) of the port arrangement (10), wherein to selectively hold the control device (16) fixed, a latching device (22) is provided, which latching device (22) has at least one latching part (26) which is guided in a guide part (24) and which, actuable by a control part (30) of the control device (16), can be placed into a latching position of a locking part (28). By virtue of the fact that, in all movement positions of a control slide (18) of the control device (16), an energy store which is preferably in the form of a pressure spring (38) is permanently supported with the one free end thereof against said control slide (18) and with the other free end thereof against the locking part (28), and that the control part (30) has a control cone (32) for at least one latching part (26) and said control part (30) also has a locking cone (34), and that the locking cone (34) has a steeper inclination than the control cone (32), no additional latching springs are required which could result in the valve device being inoperable in the event of failure.

The invention relates to a hydraulic valve device having a fluid port arrangement and having a movable control device for at least partially activating individual ports of the port arrangement, for selectively securing the control device there being a latching device which has at least one latching part which is guided in a guide part and which can be moved by a control part of the control device in an actuatable manner into a latching position of a locking part, for a latching process under the influence of the latching part which has been moved by means of the control part out of an initial position, the locking part traveling opposite the direction of movement of the control part into a receiving position for receiving the latching part and, when latching begins, returning into its initial position, and the locking part traveling against the action of an energy storage device out of its initial position into the receiving position and returning into its initial position with the action of the energy storage device.

In mechanically actuated so-called load sensing valves, working positions such as raising, lowering, or the floating position are often fixed in a predefined position by way of a specific latching mechanism. The valve slide latches in this position and can only be released from the respective latching position by an actuating force in the opposite direction.

The biggest problem with the latching position is inherently the excess mechanical cost compared to valves without this latching function, which is reflected in the form of production and mounting effort and the resulting costs. Furthermore, the control slide as a control part of the control device is permanently loaded with a transverse force and as a result causes hysteresis by friction; this can lead to impediments in operation.

All latching mechanisms for latching a valve slide as a control part, as is shown, for example, in DE 601 11 659 T2 and EP 1 446 599 B1, share the feature that for this latching function an additional spring is needed which with its force presses a thrust piece as a latching part (latching pin or latching ball) onto a predefined contour, in which groove-like depressions are made, depending on the control slide stroke. If the latching part is pressed into this depression under the influence of the transverse force, as a result of the resulting friction force between the latching part and the contour, a force must be axially applied to the control slide as the control part in order to move the latching part out of the groove depression again, to compress the springs of the latches and thus to be able to further adjust the valve slide. This necessary force for overcoming the latching mechanism will be referred to hereinafter as latching force.

The working springs of the valve slide try to push the valve slide back again into the neutral position against the actuating force and the latching force. If the latching force is greater than the spring force of the working springs, the system is made self-locking. The slide remains in the latched position until an actuating force exerted by the operator helps overcome the difference between the latching force and the spring force of the working springs. In order to minimize the aforementioned transverse forces, generally in the known solutions, two to three of the latch parts including the cam disk and latching springs are attached symmetrically to the piston diameter. If the spring for the latching mechanism breaks accidentally, this, however, leads to failure of overall function.

EP 0 023 602 A1 discloses a generic hydraulic valve device with a fluid port arrangement and with a movable control device for at least partially activating individual ports of the port arrangement. For selectively securing the control device, there is a latching device which has at least one latching part which is guided in a guide part and which can be moved by a control part of the control device in an actuatable manner into a latching position of a locking part.

For a latching process, the locking part, under the influence of the latching part which is moved by means of the control part, travels out of an initial position opposite the direction of movement of the control part into a receiving position for receiving the latching part. When latching begins, the locking part moves back into its initial position. The known solution for its proper function requires several energy storage devices in the form of compression springs. The latter can lead to hindrances in operation; this has an adverse effect on operating reliability.

Proceeding from this prior art, the object of the invention is to further improve the known solutions such that a latching mechanism for the described hydraulic valve device is formed in a manner which saves installation space and which is reliable and economical. This object is achieved by a hydraulic valve device with the features of claim 1 in its entirety.

In that, as specified in the characterizing part of claim 1, the energy storage device, designed preferably in the form of a compression spring, is permanently supported in any travel position of the control slide of the control device with its one free end on this control slide and with its other free end on the locking part, in that the control part has a control cone for the respective latching part, and a locking cone, and in that the locking cone is more heavily sloped than the control cone, no additional latching springs are needed which may break and could lead to the valve device becoming inoperable. In this respect, the operating reliability for the hydraulic valve device according to the invention is increased with only one energy storage device, preferably in the form of a compression spring.

As is further described in the characterizing part of claim 1, the control cone is followed by the locking cone with a greater taper which is therefore designed such that the latching force in any case becomes larger than the release force of the compression spring as the sole energy storage device. The latching force can be regarded as an axial component of the normal force which is transferred by the preferably conically made latching parts on the taper. Because it is necessary to press against the compression spring in the latching process and upon unlatching the compression spring provides support, the two cone angles of the control cone and the locking cone are designed to be different. In this respect, the system of the latching device is self-locking, and unintentional unlatching processes can be reliably avoided in this way; this also contributes to operating reliability.

The described structure of the guiding and locking part allows simple mounting since overall few insert parts are needed for implementing the latching device, and the components for the latching device can be economically mated without special devices. In this respect, the insert parts can be designed as simple turned parts, especially within the scope of the sleeve-like guiding and locking part. The latching device, which is preferably designed as a top part, can be accommodated within the valve device in a manner which saves installation space.

Other advantageous embodiments of the hydraulic valve device according to the invention are the subject matter of the dependent claims.

The valve device according to the invention is detailed below using one exemplary embodiment according to the drawings. The figures are schematic and not to scale.

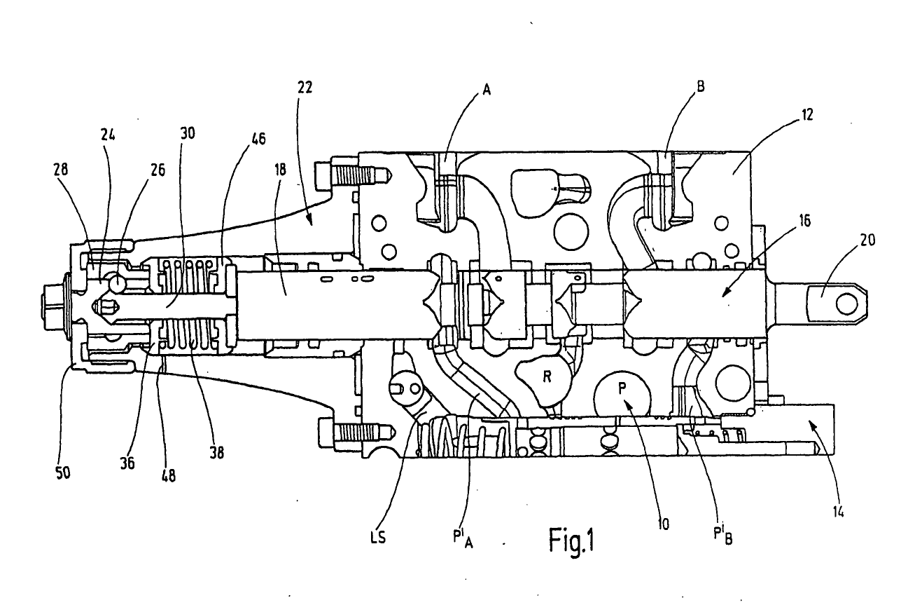

FIG. 1 shows a longitudinal section in a front view of one part of the hydraulic valve device, with the latching device actuated for latching a floating position as the fourth position of the valve;

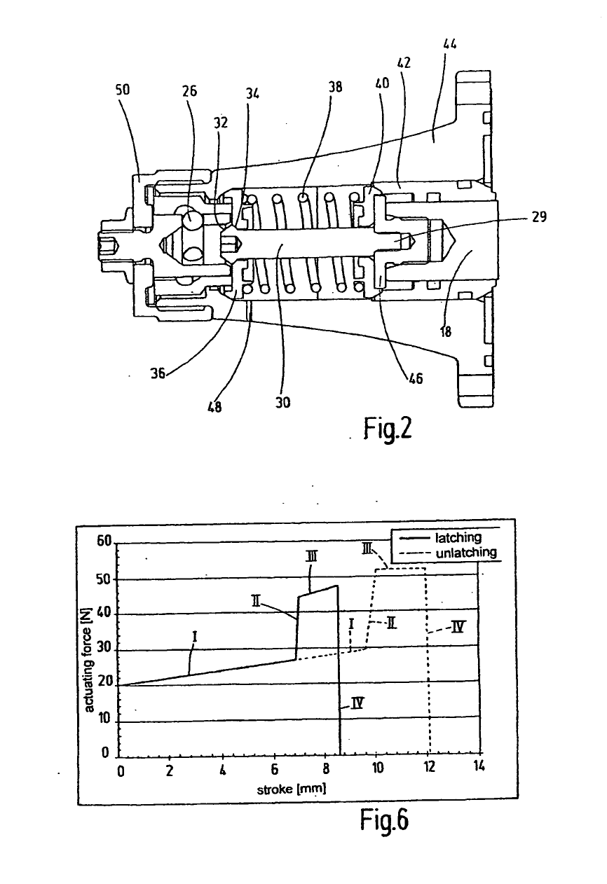

FIG. 2 shows an enlarged view of the latching device in an initial or rest position;

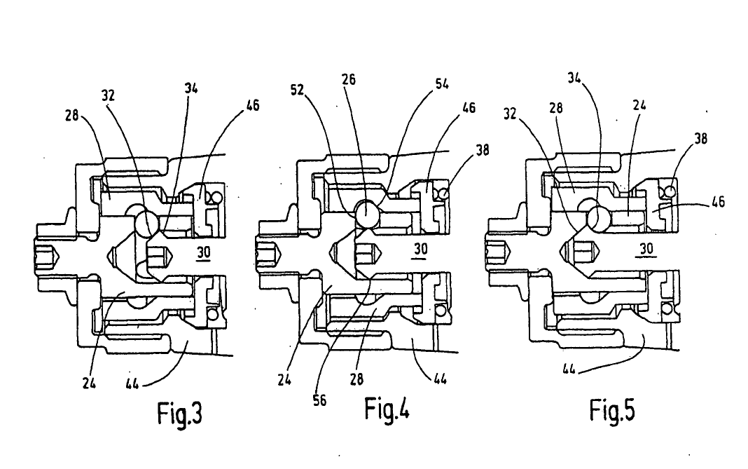

FIGS. 3 to 5 show one part of the latching device as depicted in FIGS. 1 and 2 in different actuation positions, and

FIG. 6 shows a graph of the force characteristics in latching and unlatching with the latching device.

The hydraulic valve device according to the invention has a fluid port arrangement which is designated as a whole as 10. This fluid port arrangement 10 has a pressure supply port P, a return port R, a section load sensing port LS, two control ports P′_{A} and P′_{B}, as well as two working ports A, B. The indicated fluid ports LS, P′_{A}, R, P, P′_{B}, A, and B are accommodated in a control housing 12, viewed in the direction of FIG. 1, the lower end of the control housing 12 being provided with a pressure compensator which is designated as a whole as 14 and which is connected upstream of the ports LS, P′_{A}, R, P, and P′_{B} and in this respect activates them. This structure of a hydraulic valve device is conventional so that it will not be further detailed here, and for the sake of a simplified representation, the pressure compensator 14 is only partially shown in FIG. 1. Furthermore, on the control housing there are two operating ports A, B to which a hydraulic device can be connected, such as, for example, a single- or double-acting hydraulic working cylinder (not shown), a servomotor (not shown), or comparable devices which can be hydraulically actuated.

Within the control housing 12, there is a control device which is designated as a whole as 16 and which has a control slide 18 which can move horizontally, viewed in the direction of FIG. 1. Depending on the actuating state of the control slide 18, it connects ports of the fluid port arrangement to the operating ports A, B in order to trigger functions when the hydraulic device (not shown) is connected, such as, for example, lifting or lowering as well as a floating position and optionally a neutral position. These actuating positions for a hydraulic device are typically prior art, so that they will not be further detailed here. The representation as shown in FIG. 1 in any case relates to the latched floating position of the valve device as a so-called latched fourth position.

Viewed in the direction of FIG. 1, on the right side there is an actuating device 20 for the horizontally movable control slide 18, for example, designed in the form of a Bowden cable, which is not detailed, and which on the cleared actuating eye of the control slide acts on the latter. On the opposite side of the control housing 12, there is a latching device which is designated as a whole as 22 and whose structure will be detailed below. The latching device 22 has latching parts 26 which are guided in the sleeve-shaped guide part 24, especially in the form of three latching balls which are opposite one another diametrically to the axis of displacement of the control slide 18 and which in the form of a cage guide are held to be able to move radially within the guide part 24. The latching balls are therefore held in a ball cage in radial bores of the latter, with the indicated bores inside having ball seats which prevent the respectively assignable latching ball from falling through.

In a concentric arrangement to the guide part 24, the latter is encompassed by a sleeve-shaped locking part 28 which can move back and forth in the lengthwise direction parallel to the travel direction of the control slide 18 on the outer peripheral side of the guide part 24 in opposite directions.

For a latching process as is shown in closed form in FIG. 1, under the influence of the latching part 26 which is moved by means of the control part 30, the locking part 28 can be moved out of an initial position or rest position as shown in FIG. 2, opposite the direction of movement of the indicated control part 30, into a receiving position as shown in FIG. 4 for receiving the respective latching part 26, and, when latching begins, the locking part 28 moves back into its initial left-hand position, as shown in FIGS. 1, 2, 3, and 5. The control part 30 is designed as a control rod, and, viewed in the direction of FIG. 2, is connected permanently to the left end part of the control slide 18 on the right side, for example, over a screw-in distance 29. If, therefore, the control slide 18 moves, it entrains the control part 30 to the same degree. On the free face-side end of the control part 30 there is a control cone 32 for the respective latching part 26, and, furthermore, the control part 30 on its rear side has a locking cone 34. To form the rotating control cone 32 and the rotating locking cone 34, the control part 30 on its free end has a corresponding peripheral thickening. For proper operation, the locking cone 34 is moreover more heavily sloped than the control cone 32.

As shown in FIG. 2 in which the latching device 22 is in the initial or rest position, the locking cone 34 is in contact with a conical recess of a guide plate 36 which can move lengthwise. This guide plate 36 is supported on its one side on a compression spring 38 as an energy storage device, and, on the opposite, other face side of the guide plate 36 the locking part 28 is guided to be able to move lengthwise in contact on the guide part 24. The other free end of the compression spring 38 is in turn in contact with a support plate 40 which is shown in FIG. 2 in contact with a stationary support sleeve 42 of the housing 44 of the latching device 22. The control slide 18 of the control device 16 extends through this support sleeve 42, and the slide is guided with its free end in the support sleeve 42. If the control part 30 moves with the control slide 18 from right to left viewed in the direction of FIG. 2 and therefore from a rest or initial position as shown in FIG. 2 into the latching position as shown in FIGS. 1 and 5, a plate-shaped guide part 46 on the free end of the control slide 18 entrains the support plate 40 to the left against the action of the compression spring 38, with the energy storage device in the form of a compression spring 38 being further pretensioned in this respect.

As further follows from FIGS. 1 and 2, the control part 30 extends through the energy storage device in the form of the compression spring 38, and the pertinent compression spring space is connected to ambient pressure via a vent bore 48 which extends through the wall of the housing 44 of the latching device 22. Furthermore, the sleeve-shaped guide part 24 is held stationary on the housing 44 of the latching device 22 by means of a union nut 50. As FIG. 4, which relates to a transition position of the latching device 22, further shows, at least the radial penetration depths of the receiving spaces 52 and 54 by the guide part 24 and the locking part 28 are chosen such that the respective latching part 26 can be completely accommodated by the receiving spaces 52, 54 under the influence of the control part 30.

As furthermore follows from FIG. 1, the control slide 18 has only one working spring in the form of the compression spring 38 for both actuation directions, for which lifting is to be implemented to the right, and lowering and the floating position to the left. The latching mechanism is divided into two component regions, with the first cone contour as a control cone 32 being functionally a component of the pretensioning screw for the working spring 38 and thus being permanently connected to the control slide 18. The ball cage with the force-transferring latching balls as latching parts 26 is arranged stationary in the rear part of the housing 44 as part of the guide part 24. The locking part 28, which is designed as a sliding sleeve with a conical turned recess as a second cone contour which discharges into the receiving space 54, is supported on the guide part 24 with the capacity to move axially in a concentric arrangement and can be displaced against the force of the compression spring 38. In the rest or neutral position as shown in FIG. 2 and in the lowering position as shown in FIG. 3, at least the locking part 28 in the manner of a sliding sleeve lies clamped axially between the end stop on the housing 44 in the form of the union nut 50 and the assigned spring plate in the form of the guide plate 36, which is kept in contact by the pretensioned working compression spring 38.

This clamping situation is also established for the locking part 28 in the fully latched position as shown in FIGS. 1 and 5. As shown in FIGS. 1 and 5, the locking part 28 is not clamped only in the transition region as shown in FIG. 4 between the lowering position as shown in FIG. 3 and the fully latched floating position as the fourth position, but, viewed in the direction of FIG. 4, is pushed to the right under the influence of the control cone 32 of the control part 30 against the action of the compression spring 38 together with the guide plate 36.

When the first cone contour, formed by the control cone 32, presses the ball-shaped latching parts 26 to the outside by the traveling motion of the control side 18 into the floating position (leftmost latching position), as described and as shown in FIG. 4, the sliding sleeve in the form of the locking part 28 is consequently pushed to the right against the working compression spring 38 until the latching parts 26 in the radial direction lie outside to such a degree that the first cone contour in the form of the control cone 32 can travel inside through the boundary of the latching parts 26 which is formed to the outside. Then, in this respect, the latching parts 26 are displaced completely into the assigned receiving spaces 52 and 54 to the outside by the guide part 24 and locking part 28 by the tapered enclosure edge 56, which constitutes the linear boundary to the outside from the control cone 32 and the locking cone 34, as shown in FIG. 4.

As already described, the control cone 32 is followed by the locking cone 34 with a greater taper, which is therefore designed such that the latching force, in any case, becomes larger than the release force of the compression spring 38. The latching force can be regarded as an axial component of the normal force which is transferred by the spherical latching parts 26 on the taper. Because it is necessary to press against the compression spring 38 in the latching process and upon unlatching, the compression spring 38 provides support, the two cone angles of the control cone 32 and the locking cone 34 are designed to be different. The result of the force-path characteristic is shown by way of example in FIG. 6, with the branch designated as I relating to the rest or neutral position as shown in FIG. 2, the branch II referring to the lowering position as shown in FIG. 3, the branch III relating to the transition region as shown in FIG. 4, and the branch IV showing the locking state as shown in FIGS. 1 and 5. The force characteristics recorded in FIG. 6 relate to the actuation force in newtons over the valve stroke in millimeters. The unlatching line which is shown dotted also shows that the latching position is locked and the control slide 18 must traverse a longer path in order to effectively cause unlatching, so that the system of the latching device 22 is self-locking and unintentional unlatching processes are reliably avoided in this way.

In the actual latching process, the control cone 32 strikes the indicated latching parts 26, where the force increases, because the spherical latching parts 26 must displace the sliding sleeve as the locking part 28 and, in doing so, further pretension the compression spring 38. When the latching parts 26 pass this site, in the latching process in the stroke range of 8.5 mm the opposing force collapses, and the control slide 18 can easily be pushed into its end position where it then stops, latched as shown in FIGS. 1 and 5 up to a stroke of 12 mm. During unlatching, the force quickly peaks because again the latching balls 26 must be overcome by the control part 30 of the control slide 18; this is in turn accompanied by the displacement process of the locking part 28, and the working spring 38 is again pretensioned.

To the extent the locking part 28 as a rotationally symmetrical sleeve-like part is provided with internally circumferential conical groove paths (not shown), the spherical latching part 26 could be allowed to run in the indicated latching grooves, and the sliding sleeve as a locking part 28 would be reliably guided rotationally fixed on the guide part 24 over the latching parts 26.

Overall, with the valve device according to the invention, integration of the functions of a required latching spring into the existing working spring (compression spring 38) of the control device 16 is achieved. As a result of the indicated cone contours, self-locking is achieved so that unintentional unlatching processes are reliably avoided. As a result of the rotational symmetry of the components used, especially in the form of guide part 24 and locking part 28, any tolerance-dictated transverse forces are equalized. Otherwise, as shown in FIGS. 1 to 5, simple plug-in and screw mounting is possible with the latching device according to the invention.

1. A hydraulic valve device having a fluid port arrangement (10) and having a movable control device (16) for at least partially activating individual ports (P), (R), (LS), (P′_{A}), (P′_{B}) of the port arrangement (10), for selectively securing the control device (16) there being a latching device (22) which has at least one latching part (26) which is guided in a guide part (24) and which can be moved by a control part (30) of the control device (16) in an actuatable manner into a latching position of a locking part (28), for a latching process under the influence of the latching part (26) which has been moved by means of the control part (30) out of an initial position, the locking part (28) traveling opposite the direction of movement of the control part (30) into a receiving position for receiving the latching part (26) and, when latching begins, returning into its initial position, and the locking part (28) traveling against the action of an energy storage device out of its initial position into the receiving position and returning into its initial position with the action of the energy storage device, characterized in that the energy storage device, designed preferably in the form of a compression spring (38), is permanently supported in any travel position of the control slide (18) of the control device (16) with its one free end on this control slide (18) and with its other free end on the locking part (28), and that the control part (30) has a control cone (32) for the respective latching part (26), and a locking cone (34), and that the locking cone (34) is more heavily tilted than the control cone (32).

2. The valve device according to claim 1, characterized in that the respective latching part (26) consists of a latching ball which is accommodated in a cage recess as a receiving space (52) of the guide part (24).

3. The valve device according to claim 1 or 2, characterized in that the locking part (28) is provided with a receiving cone as part of another receiving space (54) for the respective latching part (26).

4. The valve device according to any one of claims 1 to 3, characterized in that the penetration depths of the receiving spaces (52, 54) of the guide and locking part (24, 28) are chosen such that the respective latching part (26) is completely accommodated by the receiving spaces (52, 54) under the influence of the control part (30).

5. The valve device according to one of claims 1 to 4, characterized in that in any travel position of the control part (30), the latter is securely connected to the control slide (18) and extends through the compression spring (38) as an energy storage device.

6. The valve device according to any one of claims 1 to 5, characterized in that both the guide part (24) and also the locking part (28) consist of sleeve-shaped bodies and that the guide part (24) is securely connected to a housing part (44) in which the control part (30) is movably guided.

7. The valve device according to any one of claims 1 to 6, characterized in that the control slide (18) is guided to be able to move lengthwise in a control housing (12), on whose one side the latching device (22) is coupled and on whose other side the actuating device (20) for the control slide (18) acts.

8. The valve device according to any one of claims 1 to 7, characterized in that effective latching with the latching device (22) takes place in the floating position of the control slide.
